(19) United States
(12) Patent Application Publication
(10) Pub. No.: US 2005/0077644 A1
(43) Pub. Date: Apr. 14, 2005

(54) High pressure liquid jet cutting system and method for forming polymer pellets

(76) Inventors: David E. Bryan, Buchanan, VA (US); Timothy N. Falls, Buchanan, VA (US)

Correspondence Address: JACOBSON HOLMAN PLLC, 400 SEVENTH STREET N.W., SUITE 600, WASHINGTON, DC, 20004, US

(21) Appl. No.: 10/917,534

(22) Filed: Aug. 13, 2004

Related U.S. Application Data
(60) Provisional application No. 60/494,797, filed on Aug. 14, 2003.

(51) Int. Cl. B29B 9/10

(52) U.S. Cl. 264/143; 425/67; 425/313

(57) ABSTRACT

A system and method for pelletizing extruded materials, such as thermoplastic polymers in various pelletizing applications, including underwater, hot face, and strand pelletizing applications, utilizes a high pressure liquid delivered to one or more nozzles which direct a high pressure liquid jet cutting stream at the extruded polymer strand to cut the strand into pellets. The system and method are particularly applicable to underwater pelletizers utilizing water or water-based solutions. In a preferred underwater pelletizing embodiment, a plurality of nozzles are mounted on a rotating nozzle hub which is fed high pressure water through sealed hollow pelletizer and hollow motor shafts. The high pressure water jet cutting streams exiting the rotating nozzles are preferably in the form of a flat V-shaped spray with a spread angle of about 15° to about 45° and an approach angle between 0° and 60°, depending upon the pelletizing application.

### RELATED APPLICATION

This application is entitled to and hereby claims the priority of co-pending U.S. Provisional Application Ser. No. 60/494,797, filed Aug. 14, 2003.

### FIELD OF INVENTION

The present invention generally relates to a high pressure liquid jet stream system and method utilized as a cutting medium for forming pellets from extruded materials, such as molten thermoplastic polymers, that eliminate the need for cutter blades and expensive die assemblies. More specifically, the present invention relates to high pressure water and water-based liquid jet streams for cutting extruded materials various pelletizing applications, including in underwater, hot face and strand pelletizing applications.

### DESCRIPTION OF PRIOR ART

Conventional cutting systems for pelletization of molten polymers and other extruded materials have been mechanical in nature and include, for example, a rotatable cutter hub and blades associated with a die plate. Conventional cutter hub and die plate arrangements of the past work well, but there always exist the mechanical wear of these items requiring service, replacement and down time. Typically, extrusion and pelletization is accomplished in underwater, hot face and strand applications. This invention is intended to be applied to all of these cutting concepts, including underwater, hot face and strand pelletizing applications.

In underwater pelletization, the extrudate is cut with rotating blades in conjunction with a die plate. Underwater pelletizers are shown in U.S. Pat. Nos. 5,059,103, 5,403,176, and 6,332,765, owned by the assignee of the instant application, and a typical prior art underwater pelletizer configuration, generally designated by reference numeral 10, is illustrated in FIG. 1. Associated with the underwater pelletizer 10 is an extrusion die plate assembly 12, an inlet housing 14 having passageway 16 therein for molten polymer diverted by nose cone 18 feeding a plurality of extrusion die orifices 20 in the die plate 12. The underwater pelletizer includes a water box or cutting chamber 22 having a water inlet 24 and a pellet and water slurry outlet 26. Operating within the cutting chamber 22 is a rotating cutter hub 28 carrying cutting blades 30 which engage the annular die face 32 of the die plate 12 to cut into pellets the molten polymer extruded out of the die orifices 20. The rotating cutter hub 28 carrying the moving blades 30 is driven by drive shaft 34 which extends through the water box 22 to a drive motor (not shown).

In hot face pelletization, the molten polymer or other material is typically cut in a fashion that is similar to underwater pelletizing; but in hot face pelletization, the die plate is not immersed in water and it is even possible to exclude water completely. Typical prior art hot face pelletizers are illustrated schematically in FIGS. 2 and 3. In FIG. 2, the pelletizer, generally designated by reference numeral 40, is horizontally positioned, where as the pelletizer of FIG. 3, generally designated by reference numeral 60 is vertically positioned.

In the hot face horizontal pelletizer 40 shown in FIG. 2, the components are virtually identical to the underwater pelletizer, except that no water is employed and the bottom of the cutting chamber is open to allow the cut pellets to fall out. The molten polymer is extruded through die orifices 42 in annular die face 43 and the extruded strands are cut into pellets by moving blades 44 which engage the die face 43. The blades 44 are mounted for rotation on rotating cutter hub 46 which is driven by motor 48 through rotating shaft 50. The cut pellets drop out through the bottom of the housing 52.

The vertical hot face pelletizer 60 shown in FIG. 3 is somewhat different. The molten polymer is introduced to the orifices 62 of the die plate 64 through inlet 66. The rotating cutter hub and knife assembly 68 is driven by shaft 70 which extends through the die plate and is driven by motor 72. The polymer pellets cut by cutter hub and knife assembly 68 are captured in a swirling water ring flow inside the bowl shaped chamber 74 which carries the pellets and water slurry out of the bottom of chamber 74 at 76.

In strand pelletization, molten strands are extruded through a horizontally arranged series of die holes, then the molten strands are cooled by immersing in a water bath or the like prior to cutting on a knife bed and rotor arrangement. There are several variations in strand pelletization that could be equipped with the high pressure water jet cutting system of the present invention. In one form of prior art strand pelletizer illustrated in FIG. 4, the strand pelletizer is generally designated by reference numeral 80. In the strand pelletizer 80, the parallel strands 82 are conveyed from the water bath (not shown) over strand guide plate 83 and into top and bottom rollers 84 and 86, respectively, over bed knife 88. A helix angle rotor 90 in cooperation with the bed knife 88 cuts the strands 82 into pellets 92 which fall downwardly and are discharged by discharge chute 94.

In another form of the strand pelletizer illustrated in FIG. 5, a horizontal (forced) strand pelletizer is generally designated by reference numeral 100. In strand pelletizer 100, the extruded molten polymer strands are conveyed over a strand guide plate 102 by upper and lower conveyor belts 104 through a water tank 106 which cools the polymer strands. The cooled polymer strands exiting the conveyor belts 104 are conveyed through rollers 108 over bed knife 110 which cooperates with rotating cutter 112 to cut the strands into pellets 114. The cut pellets then exit by cooling chute 116.

Another prior art strand pelletizer, with a water cascade, generally designated by reference numeral 120 is illustrated in FIGS. 6A-C. In the strand pelletizer 120, water is fed to a cascading device 122 through opening 124 which allows the water to cascade down chute 126. The parallel molten polymer strands 128 pass over the cascading device 122 and engage the water cascading down chute 126 before entry into the chopping chamber 130. In the chopping chamber 130, the now chilled polymer strands 128 pass between rollers 132 and are chopped into pieces 134 by the blades 136 on cutting rotor 138 of the angled feed dicer generally designated by reference numeral 140.

All of the prior art pelletizers, including underwater pelletizers, hot face pelletizers and strand pelletizers, suffer a major drawback in that they all have parts which wear during the cutting operation. In underwater pelletizing, the blades wear and must be periodically replaced. The die face also wears due to the friction of the blades thereagainst, especially around the die orifice exits, which can cause distortion to the formed pellets. The blades can be replaced and the die face repaired, or the die replaced, only by shutting down the equipment, which can result in considerable down time. Similarly, in hot face pelletization, blades must be replaced and the die face suffers considerable wear. In strand pelletization, the cutting elements, including the bed knife and cutter, suffer wear and must be replaced during down time of the pelletizer.

Thus, the current state of the art for extrusion pelletization requires substantial cutting blade, die plate and cutting component repair and replacement which results in substantial downtime of the equipment and lost operator time. These conditions are particularly troublesome in applications which require continuous processing where upstream equipment cannot be stopped.

Further, waterjet assemblies and the use of high pressure abrasive waterjet cutting systems and methods for cutting metal and structural components have been know. See, for example, U.S. Pat. Nos. 6,021,699, 6,077,152, 6,293,020, 6,402,587, 6,488,221, 6,533,640 and 6,540,586.

### SUMMARY OF INVENTION

In order to overcome the drawbacks of existing pelletizing systems, the present invention incorporates a high pressure liquid (water) jet cutting stream to cut the extruded strands instead of mechanical blades, cutters or choppers. Water is clearly the preferred liquid for the high pressure jet cutting stream used in the present invention, especially in connection with underwater pelletizing, although other liquids besides water could be used. While “water” will be used to describe the liquid for this invention hereafter, it is not intended that the invention be so limited. Further, the water jet stream may include additives as desired or necessary. For example, in an underwater pelletizing application, the water in the high pressure water jet stream may include additives similar to those included in the water bath, such as surfactants, emulsions, etc., as well as possible additives to assist in cutting the pellets at the die face without otherwise impairing the die face itself. For hot face and strand pelletizing applications, liquids other than water may be more suitable, and may be selected depending upon the polymer or other extruded material to be pelletized.

The utilization of a high pressure water jet cutting stream for forming pellets in an underwater pelletizer is a unique concept in underwater pelletizing of thermoplastic polymers compared to traditional underwater pelletizers which utilize rigid cutting blades. The cutting blades used in underwater pelletizing are usually made of various grades of metal to cut the molten polymer into pellets which solidify and are then carried in a slurry from the cutting chamber. This type of underwater pelletizer is disclosed, for example, in U.S. Pat. No. 6,332,765 issued Dec. 25, 2001. These cutting blades and the die face are subject to the wear as the blades engage the surface of the die face during cutting of the pellets.

In lieu of the blades and their association with the die face, the present invention utilizes a high pressure stream of water (or water-based liquid) directly concentrated in a controlled pattern on the extrusion face of the die plate in order to cut the molten polymer into pellets. This arrangement eliminates the expense of blades as well as die plate face refurbishment which results in production loss due to down time when replacing the blades and/or refurbishing the die face. The high pressure jet cutter stream system and method of the present invention also eliminates the necessity of adjusting the pelletizer to compensate for blade wear while the pelletizer is in operation.

The concept of utilizing a high pressure jet stream of water is a unique concept in pelletization when used with various types of pelletizers but is especially unique when used in an underwater pelletizer in which a stream of molten polymer is continuously fed through the die plate and due to the lack of wear, utilizing the jet stream system enables the pelletizer to stay online continuously for days and even weeks. This continuous operation is especially useful for applications that require continuous processing where upstream equipment cannot be stopped, such as virgin polymer applications, including PET and polyamides such as nylon. Also, the water used in the jet stream pellet cutting system is preferably the same composition and temperature as the water introduced into the cutting chamber for transporting the cut pellets from the cutting chamber for further processing.

In the operation of a traditional underwater pelletizing system, a water tank is provided that supplies water to the cutting chamber for quenching and solidifying the pellets and conveying the pellets to a centrifugal dryer. The same water tank which supplies quenching water to the cutting chamber also preferably supplies water for cutting the pellets by utilizing a high pressure water pump connected with the water tank. The high pressure pump includes an output connected to the pelletizer by a flexible high pressure hose with a quick disconnect coupling at the pelletizer connection. The high pressure water is pumped into a rotary union which allows the stationary water connection from the hose to feed water into a sealed rotating water transfer tube by a transfer adapter joined to the rear of the motor shaft with a coupling. By joining the adapter to the motor shaft, excessive torsional forces on the water transfer tube is eliminated. The water transfer tube is inserted through the hollow motor shaft and carries the high pressure water from the rotary union through the hollow motor shaft to the nozzle hub of the nozzle assembly. The water transfer tube is threaded to the nozzle hub and the nozzle hub has water flow channels formed in it for guiding the high pressure water to the spray nozzles.

In an alternate configuration, the water transfer tube is eliminated and the high pressure water is a supplied directly through the hollow motor shaft which is sealingly connected to a hollow rotating pelletizer shaft. The action end of the pelletizer shaft is then sealingly connected to the nozzle assembly which includes a nozzle hub and the spray nozzles. At the other end, the fan end of the motor shaft has threads machined therein for installing the rotary union.

A plurality of spray nozzles are threaded into the nozzle hub, preferably around the hub periphery. The nozzles are arranged so that the discharged spray is preferably a controlled flat jet of water in a V-shaped pattern whose leading edge generally extends across the width of the annular die face. The V-shaped water jet is also angled at an approach angle to the plane of the die face to facilitate the cutting of the extruded strands into pellets. The preferred V-shaped pattern for the flat water jet can have a spread angle, i.e., the angle between the outside edges of the V-shaped water pattern, between about 15° and about 45°, and preferably between about 20° and about 30°. The approach or cutting angle can vary from 0° (horizontal) to about 60°. An approach or cutting angle of about 20° to about 35° is preferable and an approach angle of about 30° is most preferred.

While flat V-shaped water jet sprays are the preferred pattern or configuration for the high pressure water jet cutting streams exiting the nozzles in accordance with the present invention, other water jet stream configurations could be used, such as cylindrical, conical, etc. Further, in strand pelletization, the cutting angle is preferably about 90°, i.e., the high pressure water jet cutting stream or spray is perpendicular to the strand being cut.

The high pressure pump generates the required water pressure for the cutting operation and could be a standard centrifugal pump or a reciprocating pump, but a reciprocating pump is the most typical for generating the pressures required for the present invention. The high pressure requirements vary depending upon the operating conditions and can range from 1,000 psi to 5,000 psi depending on the application. Typically, the pressure range should be 2,000 to 4,000 psi with a pressure of about 3,200 psi being used for most cutting operations. The rpm of the nozzle assembly or nozzle hub should be similar to the typical rpm of a conventional pelletizer cutter hub and should range between about 500 and 4,000 rpm, preferably near the higher end of the range or about 3,600 rpm for use in accordance with the present invention.

In view of the high pressure of the water entering the cutting chamber through nozzles of the water jet cutting system and method of the present invention, the cutting chamber should preferably be equipped with a safety by-pass pressure relief valve and water circuit. The safety by-pass pressure relief valve would permit water from the cutting chamber or water box to exit to a separate circuit in the event the pressure in the cutting chamber or water box becomes excessive. This safety by-pass would thus serve to prevent damage to the equipment and possible harm to the operators.

Water flow rates for the spray nozzles for the present invention generally range from 1 gallon per minute (gpm) to 15 gpm per nozzle depending on the nozzle orifice selection. Most applications require from 2 gpm to 6 gpm per nozzle with approximately 3 gpm per nozzle being used for most operations. The spray nozzles are arranged on the nozzle hub with a minimum of two nozzles for each hub up to as many as twenty nozzles depending upon various factors of operation. The number of nozzles on the nozzle hub depends on the production rate of the polymer to be cut and the size specifications for the pellets being cut.

Accordingly, it is an object of the present invention to provide a high pressure water stream cutter system and method for thermoplastic pellets for underwater, hot face and strand applications in which the blades and other mechanical cutting implements can be eliminated.

Another object of the present invention is to provide a high pressure water stream cutter system and method in accordance with the previous object which can operate continuously without unnecessary down time for replacement of worn blades or other worn cutting implements.

A further object of the present invention is to provide a high pressure water stream cutter system and method in accordance with the preceding objects for underwater pelletization in which the jet cutting water provides a portion of the water used to carry the pellets away from the die face and out of the pelletizer.

A high pressure water stream cutting system and method for thermoplastic pellets in accordance with the present invention has the following advantages over conventional pelletization applications:
1) Eliminates the blades and wear relationship of conventional underwater, strand and hot face pelletizing applications for economy of operation.
2) Provides a safer machine as the operator is not exposed to sharp blade edges thereby enhancing safety during operation.
3) In the use of strand units which typically cut solidified materials, wear is greatly reduced and noise is also greatly reduced by the utilization of water jet streams.
4) Provides higher frequency of cuts per strand than normally obtained on mechanical set ups to produce smaller pellets.
5) Lowers die plate pressures and thrust pressures by cutter assemblies on many applications by eliminating the use of cutter blades in hot faced and underwater applications which blades actually temporarily close the holes during operation. Such closure, even temporarily, can require complex pelletizer designs that deliver force to cutter assemblies.

While embodiments of the present invention have been described with regard to thermoplastic polymers, it is contemplated that the fluid jet cutters in accordance with the present invention can be utilized with other polymer or extrudable material, or with any suitable strand material. Further, while the present invention has been described using water as the jet cutting stream material, those skilled in the art will recognize that various additives could be included in the water to assist depending on the design of the equipment and the material to be pelletized.

The foregoing, together with other objects and advantages of this invention, which will become subsequently apparent, reside in the details of construction and use as more fully hereinafter described and claimed, reference being had to the accompanying drawings forming a part thereof, wherein like numerals refer to like parts throughout.

### DESCRIPTION OF THE DRAWINGS

The drawings serve to illustrate the present invention, but are not intended to be drawn to scale.

FIG. 1 schematically illustrates a conventional prior art underwater pelletizer.

FIG. 2 schematically illustrates a conventional prior art horizontal hot face pelletizer.

FIG. 3 schematically illustrates another type of hot face pelletizer, a vertically oriented hot face pelletizer.

FIG. 4 schematically illustrates one form of conventional prior art strand pelletizer.

FIG. 5 schematically illustrates another form of conventional prior art strand pelletizer.

FIGS. 6A, 6B and 6C schematically illustrate yet another conventional prior art form of strand pelletizer (cascading).

FIG. 7 schematically illustrates an underwater pelletizer for thermoplastic pellets using a high pressure water jet cutting system in accordance with the present invention.

FIGS. 8A-D illustrate variations in the die face structure to create optimum shear surfaces for more efficient cutting of a polymer strand by high pressure water jet streams.

FIG. 9 illustrates another embodiment of the high pressure water jet cutting system for thermoplastic pellets in accordance with the present invention.

FIG. 10 is a perspective view of one embodiment of a rotating nozzle assembly for an underwater pelletizer in accordance with the present invention, having a pair of nozzles for high pressure water jet streams to cut the molten strands into pellets.

FIG. 11 is a perspective view of another embodiment of a rotating nozzle assembly for an underwater pelletizer in accordance with the present invention, similar to the nozzle assembly of FIG. 10, but having five nozzles positioned on the hub.

FIG. 12 is another perspective view of the nozzle assembly of FIG. 11, showing the location of all five nozzles spaced around the hub.

FIG. 13 is a front side perspective view of another embodiment of nozzle assembly for an underwater pelletizer in accordance with the present invention, showing six spray nozzles.

FIG. 14 is a side elevational view of the nozzle assembly of FIG. 13.

FIG. 15 is a side elevational view, with portions in section, illustrating further details of a high pressure water jet cutting system incorporated into an underwater pelletizer in accordance with the present invention, showing the path of the high pressure water from a high pressure pump through a rotary union and adapter connected to a high pressure water transfer tube associated with a hollow motor shaft driving the nozzle hub.

FIG. 15A is a side elevational view, similar to FIG. 15, illustrating a high pressure water jet cutting system in which the high pressure water from the high pressure pump passes directly through the hollow motor shaft to the nozzle hub.

FIG. 15B is a side elevational view, with portions in section or omitted, illustrating the high pressure water jet cutting system of FIG. 15A.

FIGS. 16A, 16B and 16C are schematic illustrations of the nozzle hub and the jet spray nozzles and the manner in which they are associated with the die face of the die plate.

FIG. 17 is a schematic illustration of the high pressure water jet cutting system of FIG. 15, showing the flow path of the high pressure water from the pump, through the rotary union, adapter and water transfer tube to the nozzle hub and nozzles.

FIG. 17A is a schematic illustration of the high pressure water jet cutting system of FIGS. 15A and 15B, showing the flow path of the high pressure water from the pump, through the flexible high pressure hose, the rotary union and the hollow motor shaft to the nozzle hub and nozzles.

FIG. 18 of a cross-sectional schematic view of a nozzle assembly from inside the cutting chamber facing the die face, showing a two-nozzle, angular V-jet spray configuration in accordance with the present invention.

FIG. 19 is a schematic view from inside the cutting chamber, similar to FIG. 18, showing another nozzle assembly with six radially spaced horizontally cutting nozzles positioned so that the water jet cutting spray is parallel to the die face.

FIG. 20 is another cross-sectional schematic view from inside the cutting chamber, similar to FIG. 18, showing another nozzle assembly with six radially spaced nozzles positioned in an angular cutting configuration so that the water jet cutting spray is angled to the die face.

FIG. 21 is another cross-sectional schematic view from inside the cutting chamber, similar to FIG. 18, showing the nozzle assembly of FIGS. 13 and 14, with the nozzles positioned in an angular cutting configuration the water V-jet cutting spray angled to the die face.

FIG. 22 is a side perspective view of another high pressure water cutting system for thermoplastic pellets utilizing rotating nozzles to deliver the cutting action in a strand pelletizer.

FIG. 23 is a side elevational view of the high pressure water stream cutter system shown in FIG. 22.

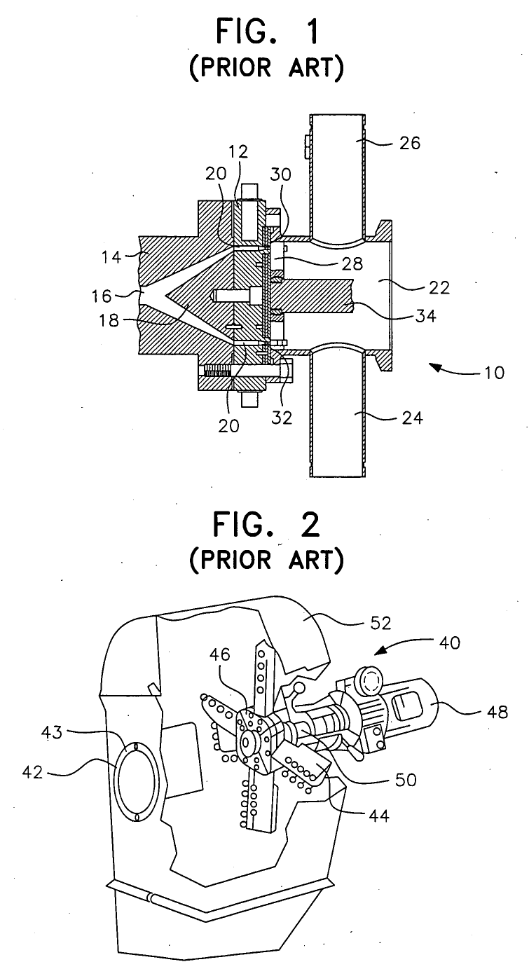

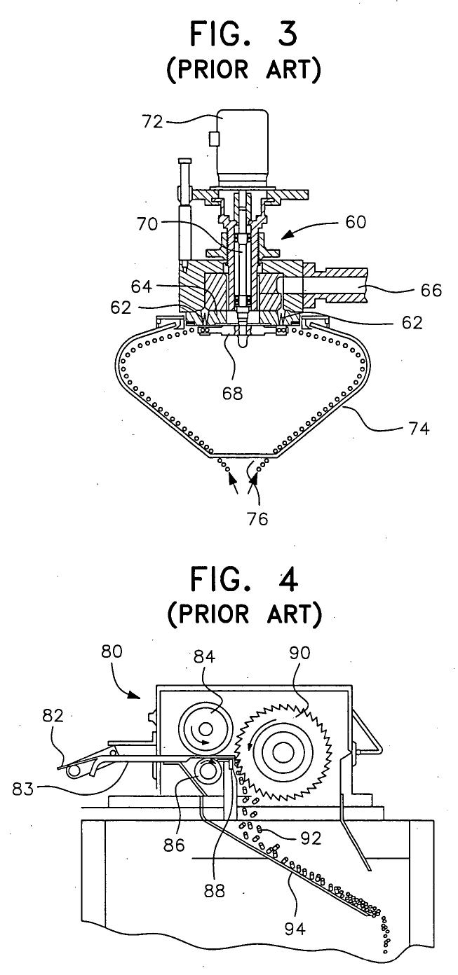

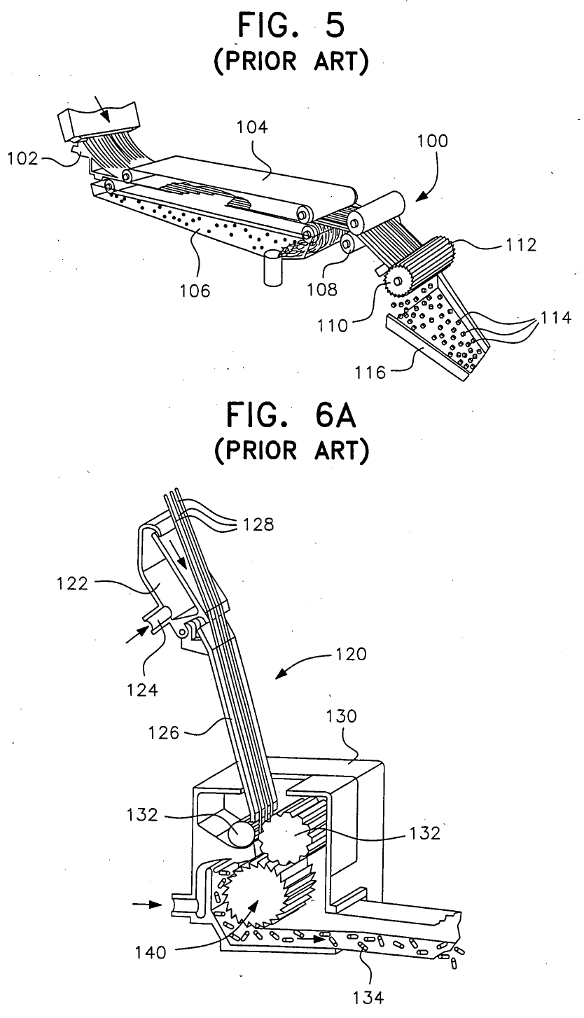

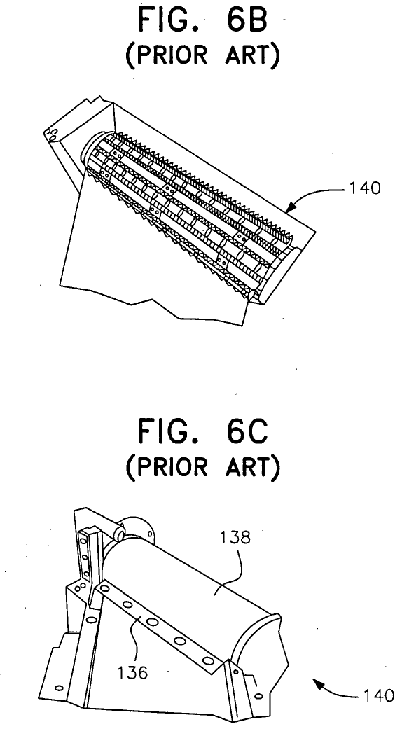

### DESCRIPTION OF PREFERRED EMBODIMENTS

Although preferred embodiments of the present invention are explained in detail, it is to be understood that other embodiments are possible. Accordingly, it is not intended that the invention is to be limited in its scope to the details of constructions and arrangement of components set forth in the following description or illustrated in the drawings. The invention is capable of other embodiments and of being practiced or carried out in various ways. Also, in describing the preferred embodiments, specific terminology will be resorted to for the sake of clarity. It is to be understood that each specific term includes all technical equivalents which operate in a similar manner to accomplish a similar purpose.

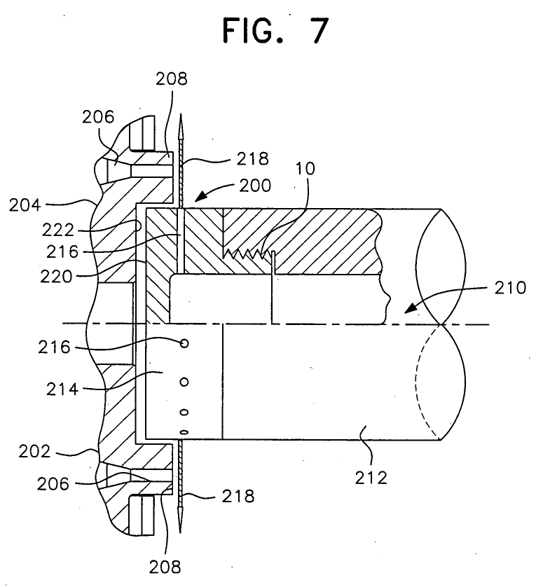

Referring now specifically to FIG. 7 of the drawings, there is schematically shown a nozzle assembly in accordance with the present invention for an underwater pelletizing system, generally designated by reference numeral 200, in relation to an extrusion die, generally designated by reference numeral 202. The extrusion die 202 includes a die plate 204 providing a plurality of extrusion orifices 206 which terminate at a raised annular or circular die face 208. A feed of high pressure water is shown at 210 entering the tubular or hollow rotatable driven shaft 212 of the underwater pelletizer. The cutting chamber or water box surrounding the nozzle assembly 200, shaft 212 and die face 208 is not shown. The high pressure water 210 enters the “cutter hub” or nozzle hub 214 which contains one or more radially extending nozzles 216, which deliver a high pressure water jet stream 218 horizontally across a shear surface formed by the die face 208 around the exit of each die orifice 206.

The die plate 204 which delivers the polymer to die orifices 206 to be cut by the rotating water jet cutting nozzles 216 is designed to accommodate the nozzle assembly 200 with close tolerances. More specifically, the end 220 of the nozzle assembly 200 is received in a cut-out 222 in the die plate 204. This arrangement permits the water jet cutting stream 218 to project horizontally across the die face 208.

The number of nozzles 216 and the speed of nozzle assembly 200 driven by the rotating shaft 212 and accompanying motor (not shown) regulate the pellet length. The high pressure water stream 218 exiting from nozzle holes 216 sever the polymer into pellets as the water stream passes over the exit to die orifices 206 which form the shear surface. The high pressure water jet streams 218 exiting each nozzle 216 approaches the shear surface as a sharp and accurate jet stream. Rotation of the high pressure water stream cuts the extruded strands into pellets and performs the “cutter hub” effect. After cutting the extruded molten strands exiting die orifices 206, the high pressure water jet streams then join with the water slurry already present in the cutting chamber or water box. The nozzle assembly 200, including the nozzles or holes 216 may be constructed in various configurations and numbers of holes to vary the output characteristics of the pelletizers, as will be explained hereinafter.

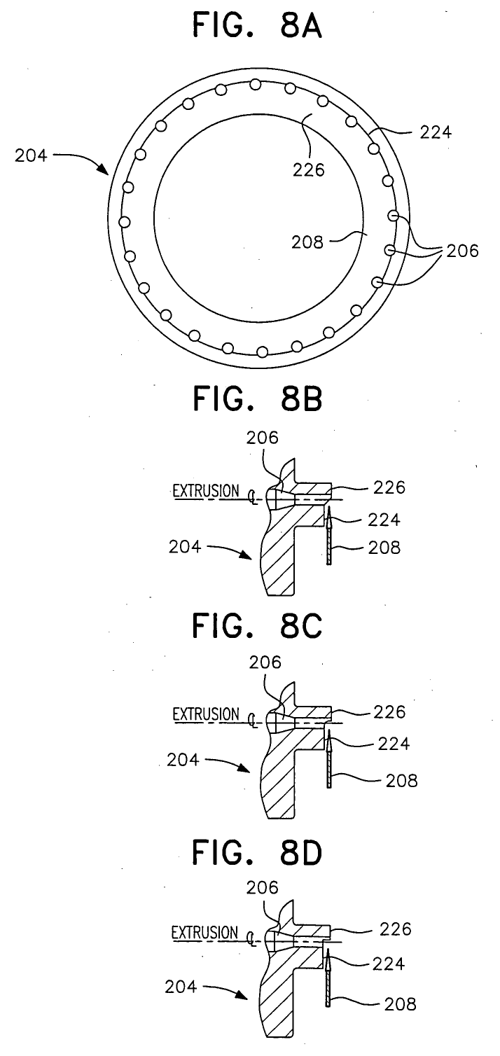

Turning to FIGS. 8A-8D, there are shown three different configurations for the outlet of the extrusion dies 206 of die plate 204. In each configuration, the outer circumference 226 of the die face 208 is raised with respect to the inner circumference 224. By having a raised outer circumference 226 at the exit of the die orifices 206, the cutting stream 208 impacts the outer edge of the die orifice hole to form a solid shear surface for cutting the extruded molten polymer and kicking out the cut pellet.

In a first configuration, FIG. 8B, the gradually increasing higher surface 226 begins at or near the circle defined by the innermost points of the die orifice exits and gradually increases in a straight line from the lower surface 224 to the higher surface 226 which begins in a circle inside the circle defined by the outermost points of the die orifice exit holes. In a second configuration, FIG. 8C, the increasing height from inner surface 224 to outer surface 226 follows a circular path, instead of a linear path. In the third configuration, FIG. 8D, the change from the lower surface 224 to the higher surface 226 is abrupt, or at a right angle.

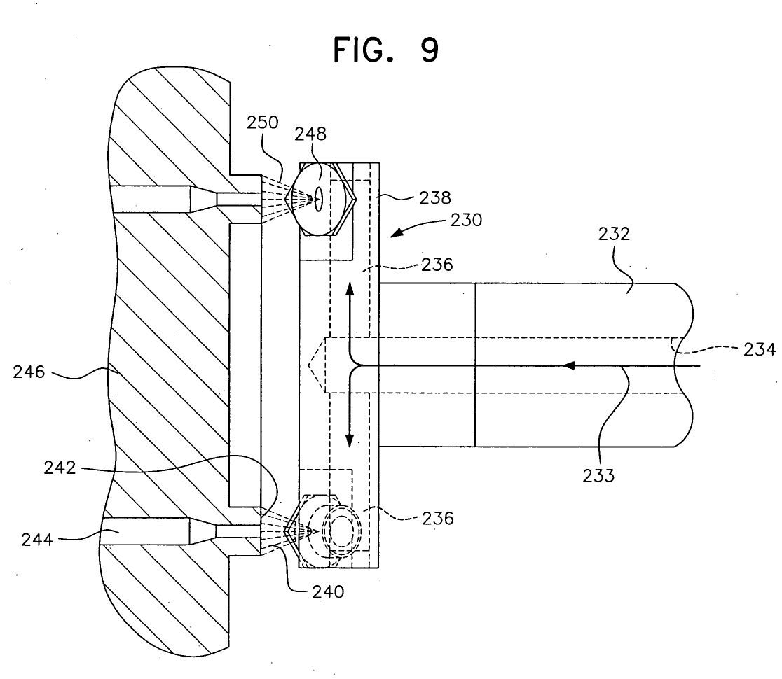

Another embodiment of the high pressure water jet cutting system in accordance with the present invention is shown in FIG. 9 in which the rotating nozzle assembly is generally designated by reference numeral 230. The rotating nozzle assembly 230 is threadedly mounted on the end of rotating shaft 232 which rotates the nozzle assembly 230 and supplies high pressure water 233 through a hollow passageway 234 in the shaft 232. The hollow passageway 234 communicates with one or more radial passages 236 in the nozzle hub 238. The nozzle hub 238 is positioned in spaced facing relation to shear surfaces 240 defined by the raised annular die face 242 at the exit end of each of the die orifice 244 in the die plate 246.

A pair of water jet nozzles 248 are mounted around the periphery of nozzle hub 238, preferably by a sealed threaded connection, in communication with each of the passages 236. Each of the passages 236 communicates the high pressure water to a nozzle 248 which, in turn, directs a high velocity water stream 250 towards the shear surfaces 240. The high velocity water streams 250 are preferably in the shape of a thin V-shaped fan to provide a cutting edge at the shear surface 240. The fan or V-shaped high velocity water streams 250 approach the shear surfaces 240 and die face 242 at an approach angle greater than 0° (horizontal) which cuts the extruded polymer strands at the shear surfaces 240 into pellets, and kick the pellets away from the die plate. The fan or V-shaped high pressure water streams 250 take the place of cutter blades and will cut a molten polymer strand into pellets as the strands emerge from the exit end of the die orifices 244 at the shear surfaces 240.

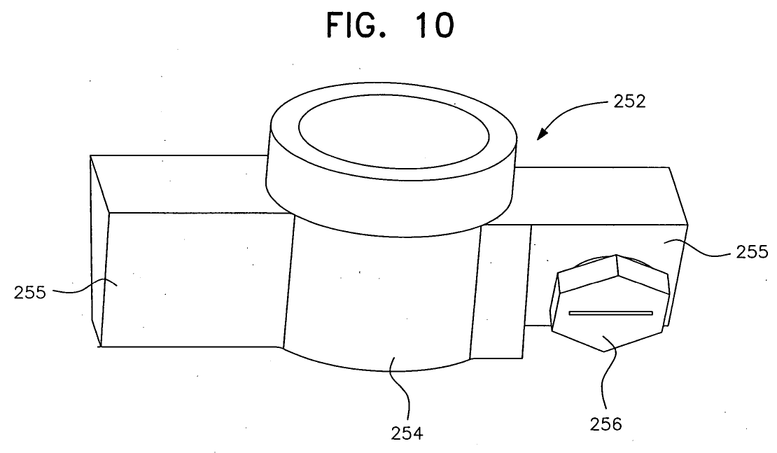

FIGS. 10-14 illustrate nozzle assemblies similar to nozzle assembly 230 of FIG. 9. In FIG. 10, the nozzle assembly is generally designated by reference numeral 252 and includes a nozzle hub 254 with a pair of radially projecting arms 255. Threadedly mounted adjacent the end of each arm 255 is a nozzle 256 which is designed to direct a high velocity water jet stream in a thin fan or V-shape configuration toward the shear surfaces at the die face adjacent the exit of the polymer extrusion die orifices, in a manner as described in connection with FIG. 9.

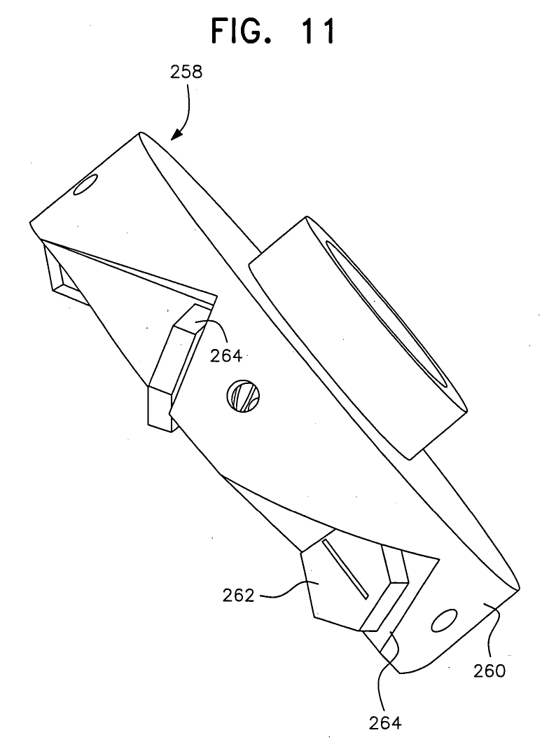

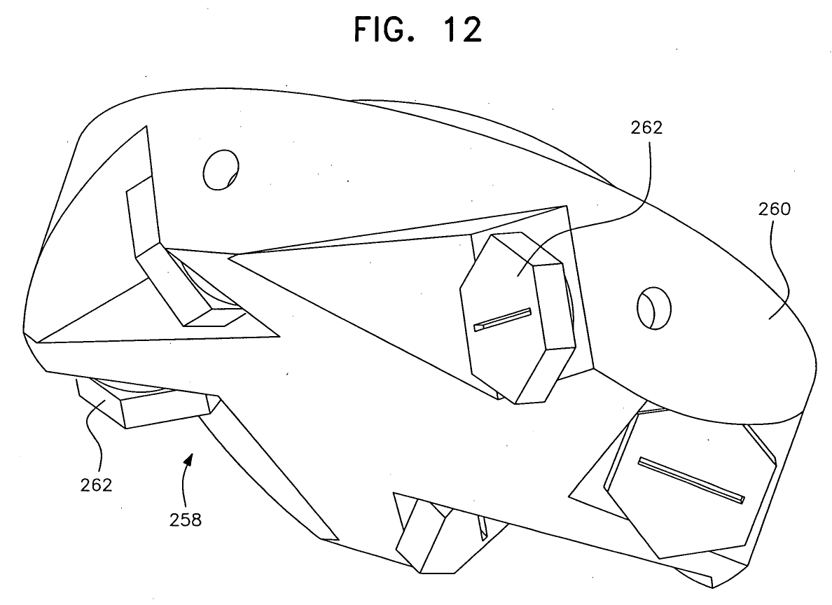

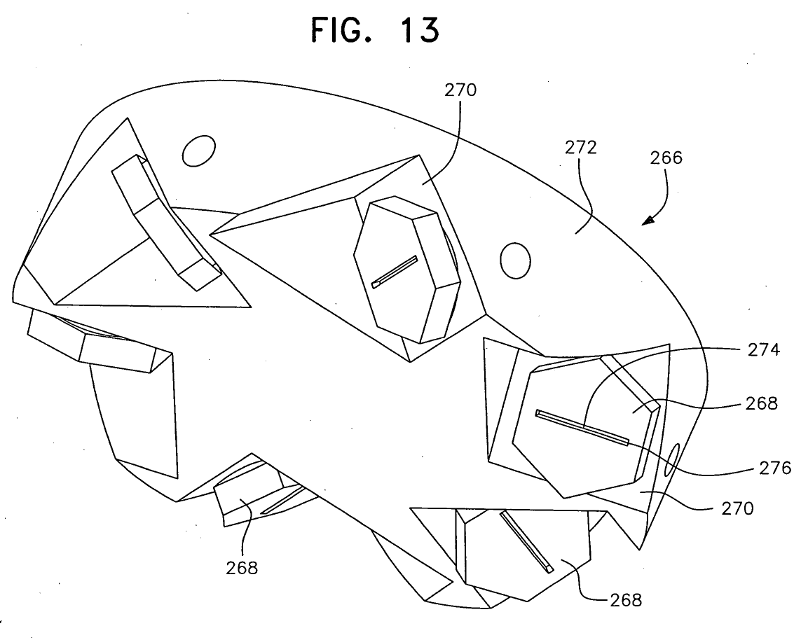

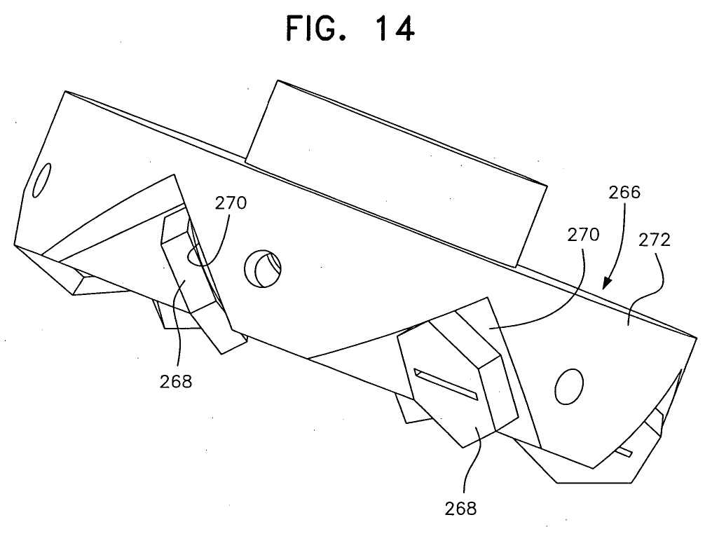

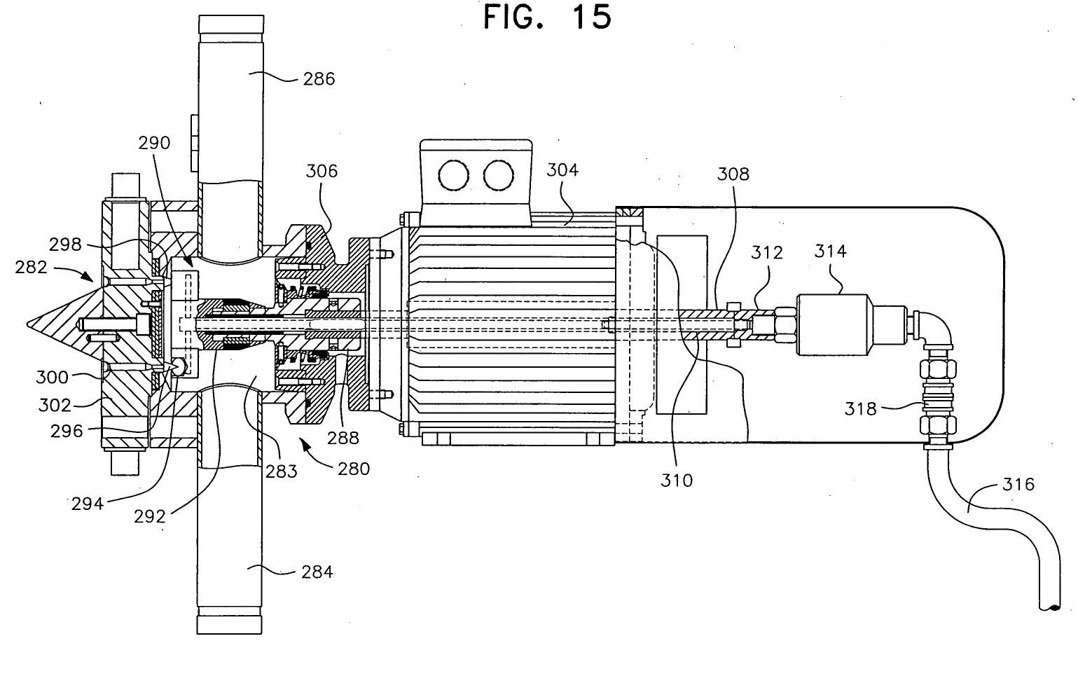

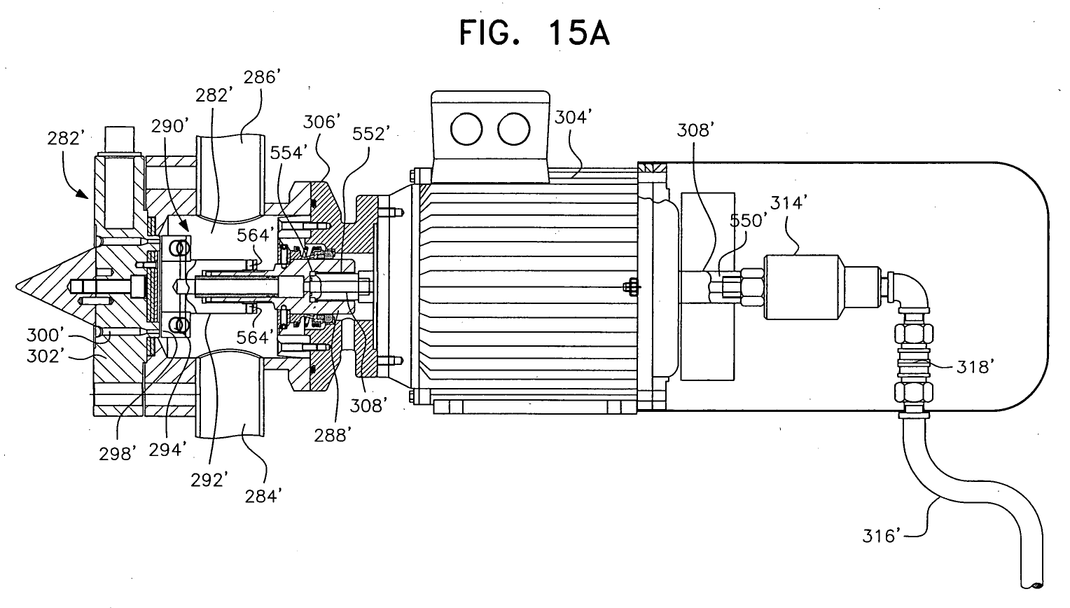

The nozzle assembly shown in FIGS. 11 and 12 is generally designated by reference numeral 258 and includes nozzle hub 260 and five nozzles 262. The nozzle hub 260 is configured with mounting surfaces 264 for mounting the nozzle 262 thereon. The angle of the surfaces 264 to the rotating axis of the nozzle assembly 258 approximates the approach angle for the high velocity water jet streams exiting the nozzles 262 toward the shear surfaces. The nozzle assembly illustrated in FIG. 13 and 14, and generally designated by reference numeral 266, is similar to nozzle assembly 258, except that nozzle assembly 266 includes six nozzles 268 mounted on surfaces 270 on nozzle hub 272.

The nozzles 248, 256, 262 and 268 shown in FIGS. 9-14 are conventional water nozzles available for delivering high pressure water jet streams. They typically include a central hole or orifice 274 (see FIG. 13) through the nozzle and an elongated slot 276 to disperse the water in a fan or V-shape. For convenience, such nozzles are hereinafter sometimes simply referred to as V-jet nozzles or V-jet spray nozzles. The fan or V-shaped water spray generated by the V-jet nozzles is hereinafter sometimes simply referred to a the V-jet spray or V-jet water spray. Such nozzles useful in accordance with the present invention are available from PNR America, LLC of Poughkeepsie, N.Y. 12601.

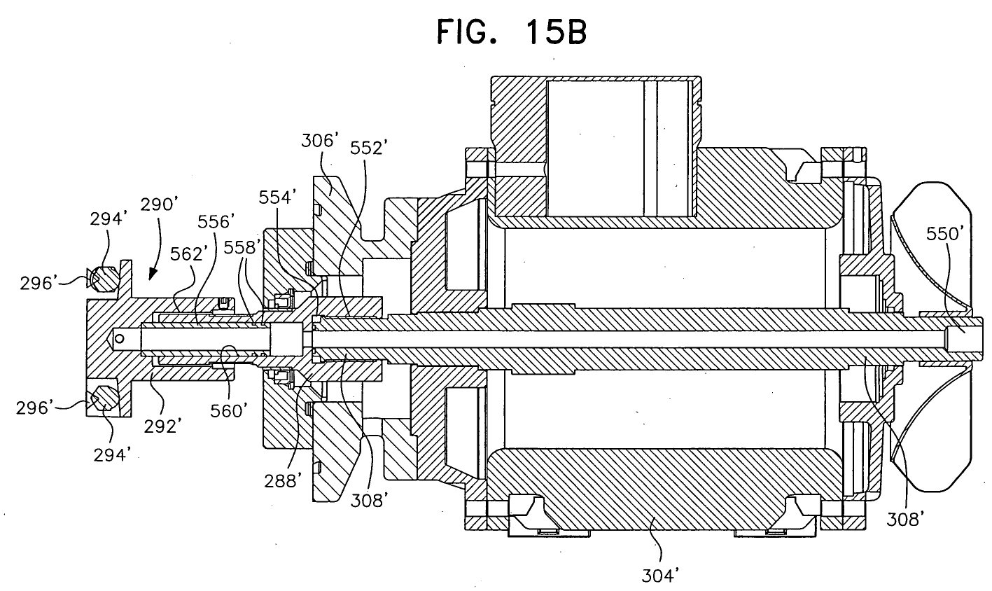

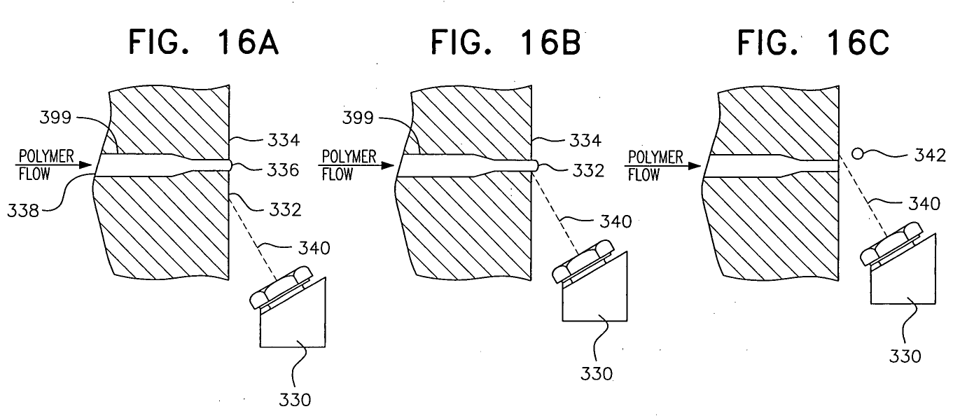

Turning now to FIG. 15 of the drawings, there is illustrated further details of the high pressure water jet cutting system incorporated into an underwater pelletizer system in accordance with the present invention. The underwater pelletizer is generally designated by reference numeral 280, which is juxtaposed to the die face of extrusion die plate generally designated by reference numeral 282. The pelletizer 280 includes cutting chamber or water box 283 with a water inlet 284 and a pellet and water slurry outlet 286. Mounted at the end of pelletizer shaft 288 is a nozzle assembly 290 having a nozzle hub 292 and a pair of high pressure V-jet spray nozzles 294. The V-jet spray nozzles 294 direct a high pressure V-jet water spray 296 against the die face 298 to cut the molten polymer exiting die orifices 300 of die plate 302.

The electric drive motor 304 is mounted on the underwater pelletizer 280 on the side opposite from the die plate 302 through motor adapter flange 306. The hollow pelletizer shaft 288 is connected to the hollow motor shaft 308. A high pressure water transferred tube 310 extends through the hollow motor shaft 308 and hollow pelletizer shaft 288 to deliver high pressure water to the nozzle assembly 290. The entrance to the high pressure water tube 310 is fitted with a rotary union adapter 312 connected to a rotary union 314 which is connected to flexible high pressure hose 316 for transmitting the high pressure water from the high pressure water pump (not shown). A quick release water connection 318 is preferably interposed between the flexible high pressure hose 316 and the rotary union 314 for ease of maintenance and assembly.

The high pressure water jet pelletizer 280′ together with the related die plate 282′ and motor 304′ shown in FIGS. 15A and 15B is the same as shown in FIG. 15, with like components carrying the same number followed by prime (′) notation, with one exception. Instead of the high pressure water transfer tube 310 in the FIG. 15 embodiment, the embodiment shown in FIGS. 15A and 15B utilizes the hollow motor shaft 308′ to deliver the high pressure water directly to the nozzle assembly 290′. The fan end of the shaft 308′ has threads machined in at 550′ for installing the rotary union 314′. The threads of the rotary union 314′ screw directly into the motor shaft threads 550′.

The drive end 552′ of the motor shaft 308′ has been machined and threaded for installing the pelletizer shaft 288′ and an O-ring seal 554′. The O-ring 554′ is installed into the O-ring groove in the end of the motor shaft, and the pelletizer shaft 288′ is then threaded onto the motor shaft 554′ until the motor shaft bottoms out in the pelletizer shaft and compresses the O-ring 554′, creating a seal so that the high pressure water will not leak between the motor shaft 308′ and the pelletizer shaft 288′. The motor adapter flange 306′ is then installed to the front face of the drive motor by four studs and nuts.

The nozzle hub 292′ has a seal tube 556′ pressed into the center of the nozzle hub during the manufacturing process, thereby making it a rigid permanent part of the nozzle hub 292′. The seal tube 556′ has two O-ring grooves on its outer circumference for receiving O-rings 558′ to seal the seal tube 556′ inside the boor 560′ of the pelletizer shaft 288′. The nozzle hub 292′, which has internal threads at 562′, is then threaded onto the external threads of the pelletizer shaft 288′ until a predetermined dimension from the front face of the nozzle hub to the sealing face of the motor adapter flange is achieved. The nozzle hub 292′ is then locked in place on the pelletizer shaft 288′ with two set screws 564′ (see FIG. 15A). The spray nozzles 294′ are then threaded into the nozzle hub 292′.

The flow of water through the high pressure water jet underwater pelletizing system shown in FIG. 15 is illustrated by the black flow in FIG. 17 and identified by reference numeral 400. Similarly, the water flow for the high pressure water jet underwater pelletizing system of FIGS. 15A and 15B is shown by the black flow line in FIG. 17A and identified with reference numeral 402.

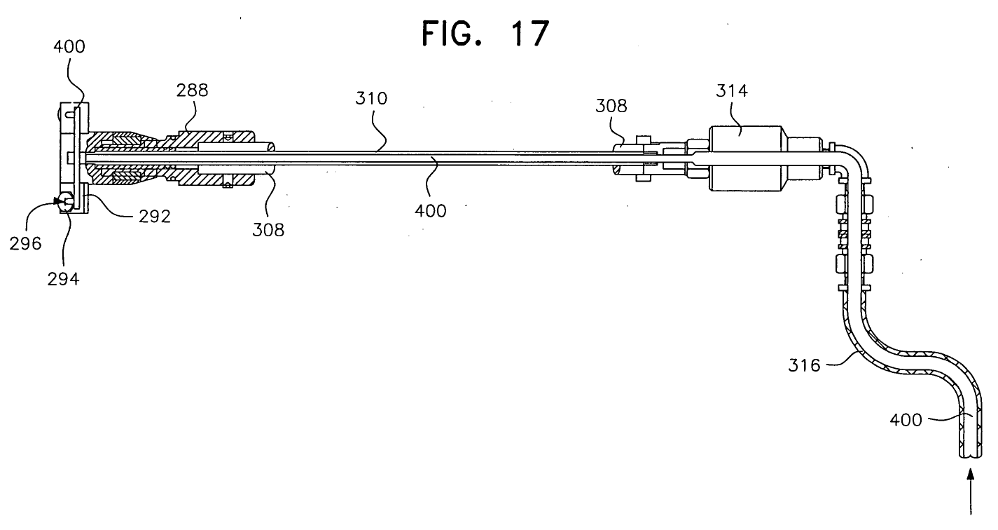

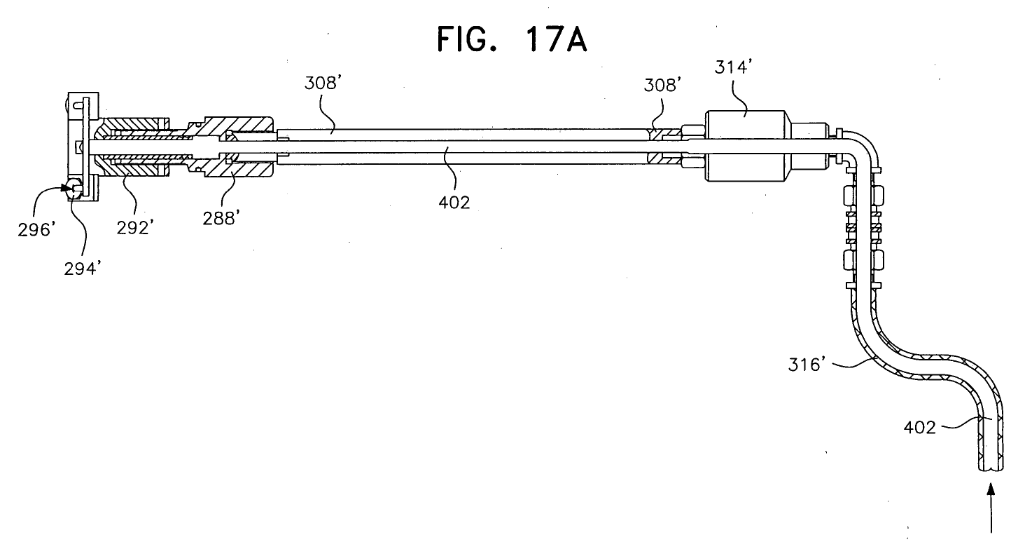

FIGS. 16A-C illustrate the cutting action of the high pressure V-jet water nozzle 330 as it progresses along the shear surface 332 formed by the die face 334 surrounding the outlet 336 of the polymer die orifice 338. As shown in FIG. 16A, the V-jet water spray nozzle 330 projects a V-jet water spray 340 at an approach angle of about 30° to the shear surface 332. The molten polymer 339 is extruding from the die hole outlet 336 as the V-jet water spray makes its approach. The polymer flow continues to extrude out of die hole 336 as the nozzle 330 moves closer and the V-jet water spray 340 makes contact with the portion of polymer 339 extending beyond the die face 334, as shown in FIG. 16B. As the nozzle 330 continues upwardly and the V-jet water spray 340 moves across the shear surface 332, the pellet 342 is cut, as shown in FIG. 16C, leaving the polymer 339 to extrude again out of die hole 336 to be cut by the V-jet water spray from the next rotating nozzle 330. The approach angle of the V-jet spray 340 also serves to kick out the cut pellet 342 from the die face 334, and the process water flowing through the cutting chamber carries the cut pellets 342 out through the water and pellet slurry outlet, such as outlets 286 and 286′, as shown in FIGS. 15, 15A and 15B.

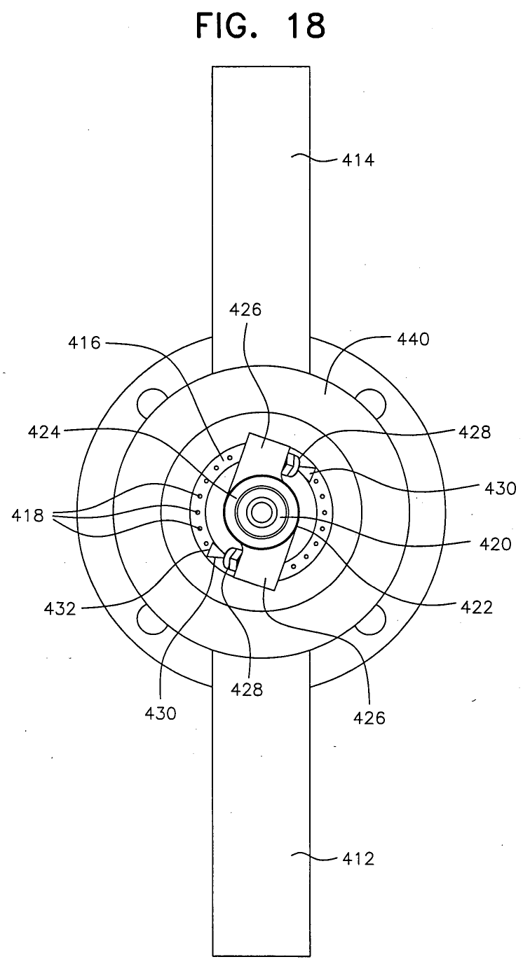

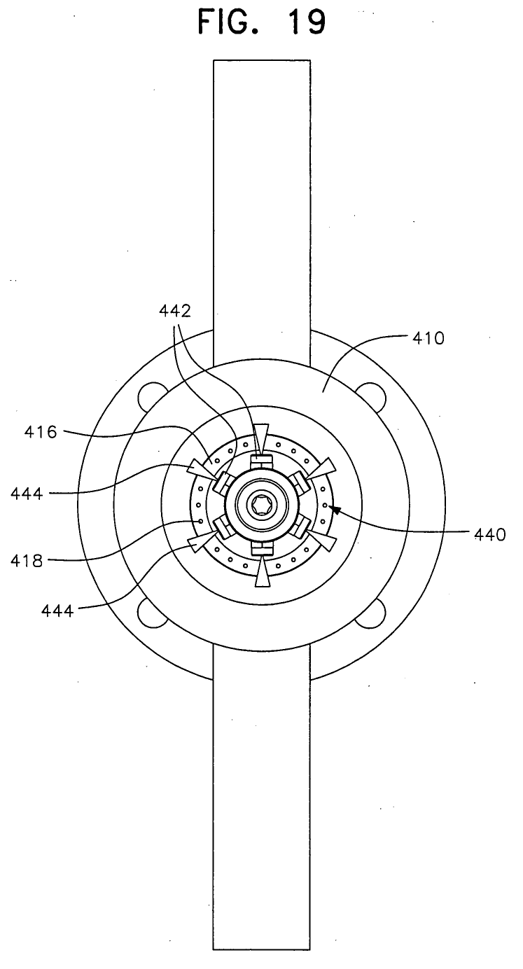

Turning now to FIGS. 18-21, there are shown various high pressure V-jet water spray nozzle assemblies for cutting extruded thermoplastic polymers and other materials in an underwater pelletizing system. As shown in these drawing figures, the underwater pelletizer includes a cutting chamber or water box 410 having a water inlet 412 and a pellet and water slurry outlet 414 and an annular die face 416 having extrusion die holes 418 circumferentially spaced around the die face. Each of the nozzle assemblies is mounted for rotation on the pelletizer shaft 420 which is driven by an electric motor as previously described. As shown in FIG. 18, nozzle assembly generally designated by reference numeral 422 includes a nozzle hub 424 and a pair of arms 426. Mounted on the ends of each arm 426 are V-jet water spray nozzles 428 which direct a V-jet water spray 430 onto the shearing surface defined by the die face 416. The nozzle assembly 422 in FIG. 18 has the same construction as nozzle assembly 254 in FIG. 10.

The V-jet water spray nozzles 428 project a V-shaped water spray 430, which preferably has its leading edge 432 designed to cover the width of the die face 416. The spread angle between the side edges of the V-shaped water spray 430 exiting from the nozzle 428 is about 25°, and the approach angle to the plane of the die face 416 is about 30°.

The nozzle assembly 440 shown in FIG. 19 has six nozzles 442 readily mounted thereon. The nozzles 442 deliver a high pressure V-jet water spray 444 which project perpendicularly to the axis of rotation of the nozzle assembly 440, or generally parallel to the die face 416. The nozzle assembly is positioned with respect to the die face 416 so that the V-jet water sprays horizontally to cut polymer extruded from die holes 418 as the nozzles 442 rotate around the die face.

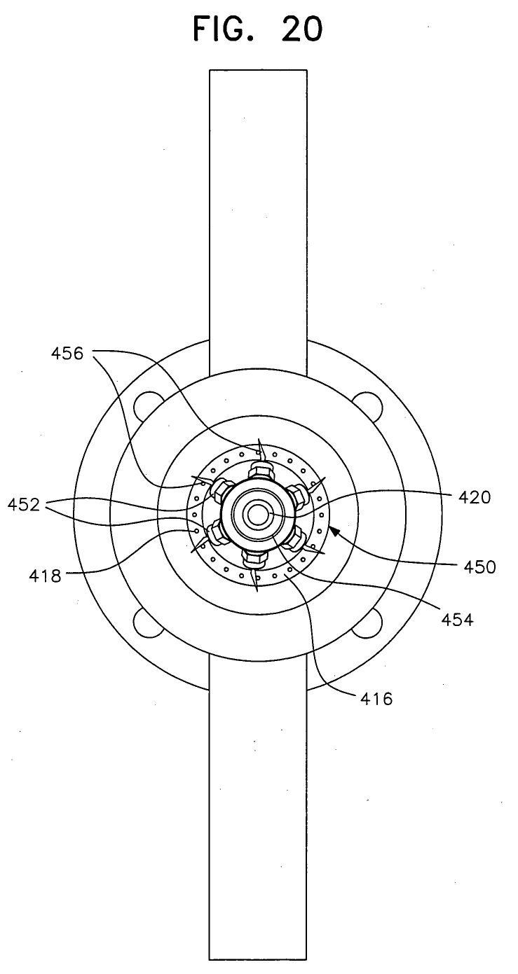

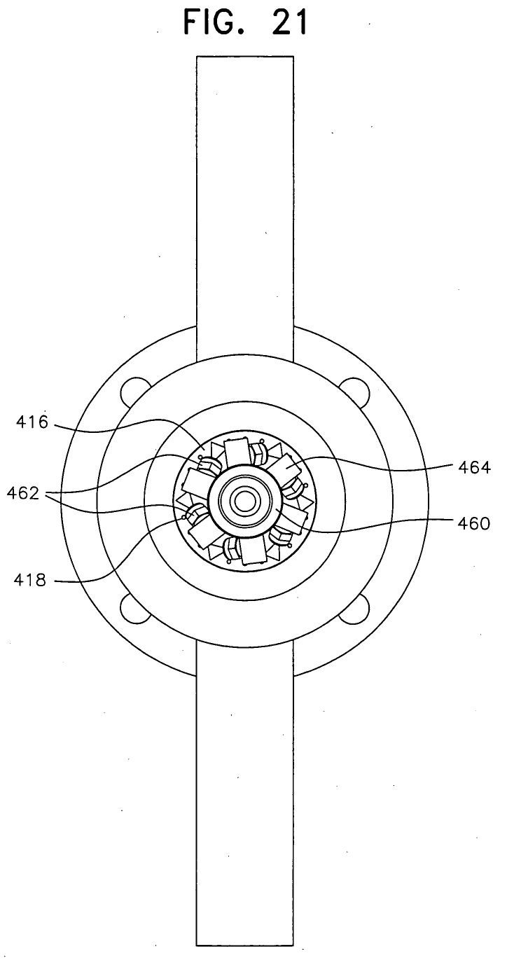

In FIG. 20, nozzle assembly 450 includes six high pressure V-jet water spray nozzles 452 spaced around the nozzle hub 454. The V-jet water spray nozzles 452 direct a V-shaped water spray 456 at a desired approach angle against the die face 416 in order to cut extruded polymer exiting extrusion die holes 418 as the nozzle assembly 450 rotates on shaft 420.

The nozzle assembly 460 illustrated in FIG. 21 includes six high pressure V-jet water spray nozzles 462 spaced around the nozzle hub 464 and is similar in construction to the nozzle assembly 266 as shown in FIGS. 13 and 14. The nozzles 462 deliver a V-shaped water spray at a desired approach angle directed against the die face 416 to cut extruded polymer exiting die holes 418 as the nozzle assembly 460 rotates around the die face.

Depending upon the configuration of the nozzle assembly, the shape of the high pressure water jet stream or spray exiting the nozzles, and the position of the nozzles in relation to the die face, the high pressure water jet stream or spray can have an approach angle to the plane of the die face between 0° (horizontal) and as much as 60°. When using a V-jet water spray, the approach angle is preferably between about 20° and about 35°, and most preferably about 30°. A V-jet water spray has a spread angle between about 15° and about 45°, and preferably between about 20° and about 30°.

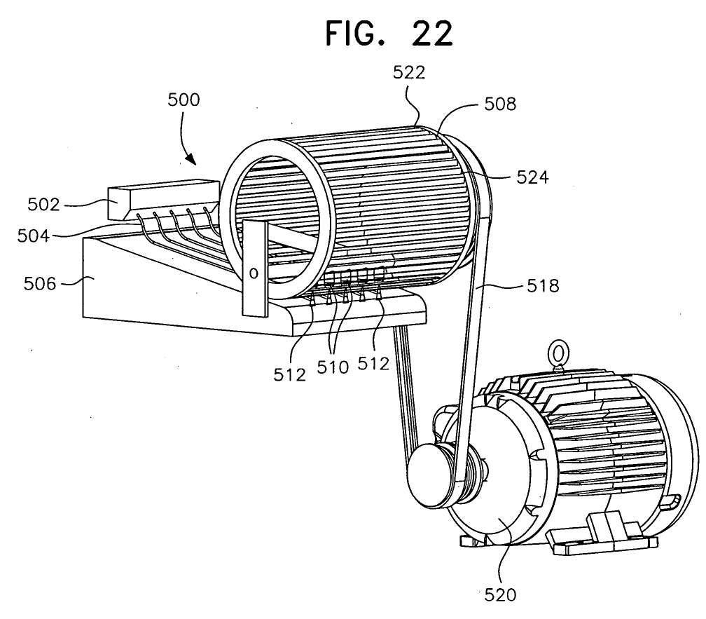

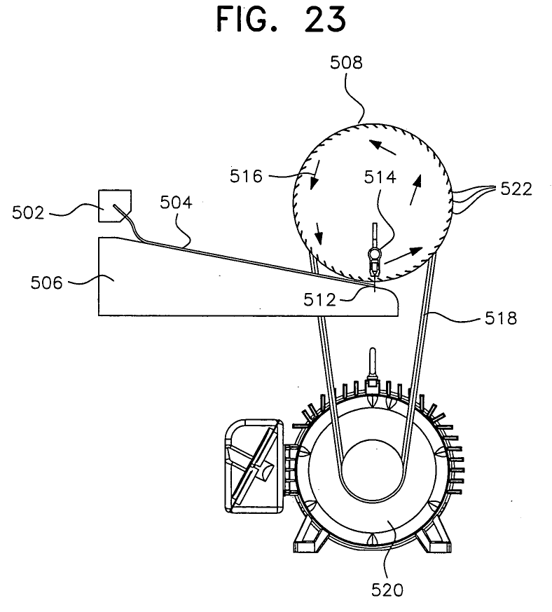

Turning now to FIGS. 22 and 23, there is shown an application of the present invention to a strand pelletizer generally designated reference numeral 500. The strand pelletizer 500 includes a die head 502 which extrudes parallel polymer strands 504 which are carried away by a slide table 506, adjustable in both vertical and horizontal directions. Mounted at the exit end of the polymer strand slide table 506 is a cylindrical rotating spray timing cage 508 and a series of high pressure V-jet water spray nozzles 510, with each nozzle 510 aligned with and spaced above an individual polymer strand 504. Each high pressure V-jet water spray nozzle 510 emits a V-shaped water spray toward its aligned polymer strand 504 at the end of slide table 506 so as to cut the polymer strand when contacted by the water jet 512. The high pressure V-jet water spray nozzles 510 are independently mounted on a spray nozzle arm 514, so as to be positioned within the spray timing cage 508, adjacent the lower side thereof. The arm 514 is preferably mounted so that the arm 514 and nozzles 510 mounted thereon can be adjusted vertically with respect to slide table 506.

The cylindrical spray timing cage 508 is mounted to rotate about its cylindrical axis in the direction shown by arrows 516 in FIG. 23. The cage 508 is also preferably mounted for vertical adjustment with respect to table 506. The rotation of the cylindrical spray timing cage 508 is driven by drive belt 518 connected to drive motor 520.

The cylindrical spray timing cage 508 has elongated peripheral angled fins or slats 522, which are spaced to leave elongated openings 524. With the high pressure V-jet water spray nozzles 514 on continuously, the angled fins or slats 522 alternately interrupt the water jets or allow them to pass through openings 524 as the spray timing cage 508 rotates. When the high pressure V-jet water sprays 512 exit through an opening 524, the sprays 512 impact their aligned strands 504 and cut the strands into pellets. As the spray timing cage 508 rotates further, the V-jet water spray 512 is again interrupted by the next angled fin 522, and the fin 522 is angled so that the interrupted V-jet water spray 512 is diverted to wash the cut pellets away from the end of the slide table 506.

### EXAMPLES

Test Equipment

The high pressure water jet cutting system and method of the present invention was tested to pelletize certain thermoplastic polymers in an underwater pelletizing application. The pelletizer assembly used in connection with the tests was as illustrated in FIGS. 15A and 15B, using a nozzle assembly as shown in FIGS. 10 and 18. The high pressure water pump was a Model 650 Triplex Plunger Pump manufactured by Cat Pumps and the rotary union was a Model 927-150-152 manufactured by Deublin. The two spray nozzles were Model FHD-1930C2SN flat jet spray nozzles manufactured by PNR America, LLC.

### Example 1

Ethylene vinyl acetate (EVA) copolymer was pelletized using the equipment described above for a period of about 2 hours under the following operating conditions:

| | |
|---|---|
| Cutter Speed (RPM) | 2000 |
| Pelletizer Motor Load (amps) | 3.8 |
| Process Water Temperature (° F.) | 102 |
| Process Water Flow Rate (GPM) | 80 |
| Cutting Water Temperature (° F.) | 85 |
| Cutting Water Flow (GPM/nozzle) | 3 |
| Cutting Water Pressure (PSI @ pump) | 2500 |
| Polymer Melt Temperature (° F.) | 445 |
| Die Hole Size (inches) | .078 |
| Number of Die Holes | 18 |
| Polymer Production Rate (lb/hr) | 100 |

The EVA polymer pellets range in size from about 0.070 inch to 0.090 inch and had a generally spherical shape.

### Example 2

Polypropylene polymer was pelletized using the equipment described above for a period of about 1 hour under the following operating conditions:

| | |
|---|---|
| Cutter Speed (RPM) | 2500 |
| Pelletizer Motor Load (amps) | 3.4 |
| Process Water Temperature (° F.) | 155 |
| Process Water Flow Rate (GPM) | 80 |
| Cutting Water Temperature (° F.) | 155 |
| Cutting Water Flow (GPM/nozzle) | 3 |
| Cutting Water Pressure (PSI @ pump) | 2500 |
| Polymer Melt Temperature (° F.) | 425 |
| Die Hole Size (inches) | .093 |
| Number of Die Holes | 6 |
| Polymer Production Rate (lb/hr) | 60 |

The polypropylene polymer pellets ranged in size from about 0.080 inch to 0.100 inch and had a generally spherical shape.

### Example 3

EVA was again pelletized using the equipment described above for a period of about 2 hours under the following operating conditions:

| | |
|---|---|
| Cutter Speed (RPM) | 2000 |
| Pelletizer Motor Load (amps) | 4.7 |
| Process Water Temperature (° F.) | 91 |
| Process Water Flow Rate (GPM) | 80 |
| Cutting Water Temperature (° F.) | 91 |
| Cutting Water Flow (GPM/nozzle) | 3 |
| Cutting Water Pressure (PSI @ pump) | 2400 |
| Polymer Melt Temperature (° F.) | 440 |
| Die Hole Size (inches) | .093 |
| Number of Die Holes | 1 |
| Polymer Production Rate (lb/hr) | 10.5 |

The EVA pellets ranged in size from about 0.080 inch to 0.100 inch and had a generally spherical shape.

The foregoing is considered as illustrative only of the principle of the invention. Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

1. A high pressure water jet system for pelletizing polymer and other materials extruded as a strand through a die orifice which comprises:
a source for high pressure water;
a nozzle which intermittently directs a high pressure water jet stream at said extruded strand to cut said strand into pellets; and
a conduit for delivering said high pressure water to said nozzle.

2. The high pressure water jet system of claim 1, wherein said system is incorporated into an underwater pelletizer, the polymer or other material is extruded through a plurality of die orifices spaced circumferentially around an annular die face, and a plurality of nozzles are mounted on a rotating nozzle hub which directs said high pressure water jet stream towards said die face and cuts said extruded polymer or other material exiting said die orifices as said nozzle hub rotates around said die face.

3. The high pressure water jet system of claim 2, wherein said underwater pelletizer includes a cutting chamber, an inlet for water into said cutting chamber and an exit for water and pellet slurry out of said cutting chamber, said high pressure water jet stream exiting said nozzle after cutting said extruded strands into pellets mixing with water in said cutting chamber and exiting as part of said water and pellet slurry.

4. The high pressure water jet system of claim 2, wherein said high pressure water jet stream is in the form of a flat V-jet spray which has its leading edge generally across said annular die face and approaches each die orifice at an approach angle between about 20° and about 35°.

5. The high pressure water jet system of claim 2, wherein said nozzle hub is rotated by a pelletizer shaft connected to a motor shaft and motor, said motor shaft and pelletizer shaft being hollow for delivering said high pressure water from said source to said nozzles through said nozzle hub.

6. The high pressure water jet system of claim 4, wherein said V-jet spray has a spread angle between about 15° and about 45°, and a leading edge which extends across an approximate width of said annular die face.

7. The high pressure water jet system of claim 1, wherein said system is incorporated into a hot face pelletizer, the polymer or other material is extruded through a plurality of die orifices spaced circumferentially around an annular die face, and a plurality of nozzles are mounted on a rotating nozzle hub which directs said high pressure water jet stream towards said die face and cuts said extruded polymer or other material exiting said die orifices as said nozzle hub rotates around said die face.

8. The high pressure water jet system of claim 1, wherein said system is incorporated into a strand pelletizer, the polymer or other material is extruded through a plurality of die orifices to produce a plurality of generally parallel strands, and a plurality of nozzles, one aligned for each strand, each nozzle intermittently directing said high pressure water jet stream towards said aligned strand to cut said strand into pellets.

9. The high pressure water jet system of claim 1, wherein said high pressure water is at a pressure in excess of 1,000 psi.

10. A method for pelletizing an extruded strand exiting a die orifice which comprises intermittently directing a high pressure water jet stream at said extruded strand to cut said strand into pellets.

11. The method for pelletizing of claim 10, wherein said pelletizing is carried out in an underwater pelletizer and said high pressure water jet stream cuts said extruded strand at an exit to said die orifice.

12. The method for pelletizing of claim 10, wherein said pelletizing is carried out in a hot face pelletizer and said high pressure water jet stream cuts said extruded strand at an exit to said die orifice.

13. The method for pelletizing of claim 10, wherein said pelletizing is carried out in a strand pelletizer having multiple, generally parallel extruded strands exiting a plurality of die orifices and a separate high pressure water jet stream cuts each of said extruded strands at a location spaced from said die orifices.

14. The method for pelletizing of claim 11, wherein said high pressure water jet stream is in the shape of a flat V-shaped spray having a spread angle of between about 15° and about 45° and approaches said extruded strand at a cutting angle between about 20° and about 35° to a plane normal to the extruded strand.

15. An underwater pelletizer which comprises a die plate with extrusion orifices terminating in a die face, a driven rotary nozzle hub supported in opposed relation to said die face, at least one high pressure water jet stream nozzle mounted on said nozzle hub to direct a high pressure water jet stream at said die face to cut strands of material extruded through said orifices into pellets as said nozzle hub and nozzle rotate around said die face, and a high pressure water source delivering high pressure water to said nozzle hub.

16. The underwater pelletizer of claim 15, wherein a plurality of high pressure water jet stream nozzles are mounted on said nozzle hub for cutting strands of material extruded through said orifices into pellets.

17. The underwater pelletizer of claim 15, wherein said high pressure water delivered to said nozzle hub is at a pressure in excess of 1,000 psi.

18. The underwater pelletizer of claim 15, wherein said high pressure water jet stream is in the shape of a flat V-shaped spray having a spread angle of between about 15° and about 45° and approaches said extruded strand at a cutting angle between about 20° and about 35° to a plane defined by said die face.

19. The underwater pelletizer of claim 17, wherein said nozzle hub is supported by a hollow pelletizer shaft driven by a hollow shaft of a motor for rotating said nozzle hub around said die face, and said high pressure water is delivered to said at least one nozzle through said hollow motor shaft and hollow pelletizer shaft.

20. The underwater pelletizer of claim 19, further comprising a rotary union between said high pressure water source and an inlet to said hollow motor shaft.
